(19) United States
(12) Patent Application Publication
(10) Pub. No.: US 2008/0271090 A1
(43) Pub. Date: Oct. 30, 2008

(54) Device, system, network and method for acquiring content

(76) Inventor: David M. Fortunato, Chester, NJ (US)

Correspondence Address: David M. Fortunato, 36 Beacon Hill Drive, Chester, NJ, 07930, US

(21) Appl. No.: 11/796,412

(22) Filed: Apr. 28, 2007

(51) Int. Cl. H04N 7/20

(52) U.S. Cl. 725/67

(57) ABSTRACT

A system, device, network and method for acquiring content that is first transmitted via satellite and received by a satellite receiver such as, for example, a satellite radio receiver. The received content may be listened to (for audio content) upon receipt by the satellite radio receiver, yet may be acquired at some later time. Alternatively, the content may be acquired in real-time—that is, at or proximate to the time during which the content is listened to (again, using audio content as an example). To acquire the content at a later time, the listener captures a part of the signal which carries the content and which is received by the satellite radio receiver. The captured part of the signal may then be transmitted to a content provider that, in turn, transmits a copy of the content identified by the part of the signal to the listener.

### FIELD OF THE INVENTION

The present invention relates to a device, system, network and method for acquiring content.

### BACKGROUND OF THE INVENTION

As used herein, the terms computer and computing device are used interchangeably and mean any electronic device that can transmit and receive a communication signal, via any medium, and that may have memory. As used herein, the term communication signal means any type of analog and/or digital signal that may be transmitted via any medium by a transmitter and that may be received via any medium by a receiver. For example, and by way of illustration and not limitation, a communication signal may be transmitted over a wired or a wireless connection. A wireless connection may include for example, and by way of illustration and not limitation, infrared, radio frequency, microwave, cellular, satellite, or other known or hereafter developed communication means that do not require a physical connection between a computing device and the transmission network via which the computing device communicates with other computing devices.

As used herein, the term content refers to electronically stored information, whether stored in analog, digital, or analog and digital format. Content includes, by way of illustration and not limitation, audio, visual, audio/visual, text, still photographs, video, animation, and any other copyrighted or copyrightable creations.

As used herein, the term portable personal entertainment device means any portable electronic device which may be used to receive, download, record, store, playback, display, edit, transmit, or upload content.

As used herein, the term memory means means a part, component, device or system which may be used to store analog and/or digital data. Memory means may be fixed as part of a computing device, or it may be removably connectable to a computing device. For example, fixed memory means may be memory chips in or connected to a computing device. Memory means may also be a compact disk, memory stick, or other data storage component that is connectable to a computing device and selectively disconnectable therefrom.

Communication between computing devices no longer requires a physical connection between the devices. For example, a computer may be equipped with an infrared transmitter/receiver that enables wireless communication between the computer and another wireless computing device such as a router or other transmission device, for example. The router or other transmission device may be still physically connected to a computer network such as the Internet, for example, but the computer communicates with the router via infrared signals. Cell phones, satellite phones, satellite computers, and satellite TV are other examples where communication between computing devices may not require a physical connection between computing devices.

As portable computing devices continue to advance in functionality and computing power, a user of the computing devices has more options for the types of activities that can be carried out by a particular computing device. For example, cell phones are becoming more and more sophisticated—with still and video cameras, games, Internet access, and more. While still not equal to a portable or stationary computer in terms of computing power, the cell phone can now perform some of the same functions as the larger portable or stationary computer.

The acquisition of content is one area in which users are demanding greater functionality and computing power from their portable computing devices. In addition, users prefer more options and choices. Cable and satellite television, for example, now offer hundreds of channels. Satellite radio is another example where user can select from hundred and perhaps thousands of stations to which to listen. However, there remain shortcomings in the acquisition of content by a user of a computing.

### SUMMARY OF THE INVENTION

The present invention is directed to a system, device, network and method for acquiring content. The content is first transmitted via satellite and received by a satellite receiver such as, for example, a satellite radio receiver. The received content may be listened to (for audio content) upon receipt by the satellite radio receiver, yet may be acquired at some later time. Alternatively, the content may be acquired in real-time—that is, at or proximate to the time during which the content is listened to (again, using audio content as an example). To acquire the content at a later time, the listener captures a part of the signal which carries the content and which is received by the satellite radio receiver. The captured part of the signal may then be transmitted to a content provider that, in turn, transmits to the listener a copy of the content identified by the part of the signal.

In accordance with embodiments of the present invention, a user has a satellite radio receiver configured to receive a signal transmitted via satellite from a first content provider such as, for example, a satellite radio station. The signal contains content such as, for example, musical content, and a content identifier that is associated with and identifies the content in the signal. The receiver has means for capturing the content identifier, and for transmitting the content identifier. For example, the receiver may comprise a satellite radio receiver and the content may be a song transmitted via satellite by a first content provider. The content identifier identifies the song with which it is associated. While listening to the song, the user may activate the capturing means and capture the content identifier for a particular song. The content identifier may identify the title of the song or artist, or other information relating to the content that can be used to identify the content. The identifier may comprise any form of data that provides some reference to the song being played on the satellite radio receiver when the user activates the capturing means. The user may capture one or more content identifiers. Once captured, the one or more content identifiers are stored in memory in the satellite radio receiver. The user may then activate a transmitter to transmit a signal having the one or more content identifiers to a content provider that may be the same as the first content provider or it may be a second content provider. An example of a second content provider may be an Internet site that enables users to download content. The content provider receives the signal with the one or more content identifiers, and then notifies the user by transmitting an acknowledgement signal by e-mail, for example. The user, upon receipt of the acknowledgement signal, can elect to acquire the content and have the content transmitted by the content provider to the user over the Internet, for example.

The following illustrative and non-limiting description of an embodiment of the present invention is provided to describe the present invention. A user tunes a satellite radio receiver to a desired station. The receiver is then configured to receive a satellite transmission from a first content provides such as, for example, a satellite radio station. While listening to the radio station, the user hears a song which he/she would like to acquire. The user activates a capture feature on the satellite radio receive that captures a content identifier for the particular song. Upon activation of the capture feature, a content identifier for the song is captured and stored in memory in the user's satellite radio receiver. The captured content identifier may comprise data transmitted by the first content provider in the satellite radio transmission with the song which the user desired to acquire. The content identifier can be used by the content provider or another content provider to identify the song desired by the user and, upon the user's request, transmit the song to the user as described in more detail below. The user may continue to capture multiple content identifiers for multiple songs. At some point, the user transmits the captured content identifiers to a content provider. The transmission may occur via satellite transmission, from the user's satellite radio receiver or other suitable transmission device. Alternatively, the user may transmit the captured content identifiers by connecting the satellite radio receiver to another computing device such as a docking station and/or computing device connectable to the Internet. The user-activated transmission of the content identifiers occurs in connection with an application resident on the user's satellite radio receiver, docking station, and/or computing device.

The content provider receives a transmission from the user with the content identifiers and with a user identifier identifying the user. Such a user identifier may be a user name, account number, e-mail address, or other anonymous or non-anonymous data that enables the content provider to identify the user and transmit an acknowledgment to the user of receipt of the content identifiers transmitted by the user.

Upon receipt of the transmission from the user, the content provider transmits an acknowledgement to the user that will acknowledge receipt of the transmission and will provide means for the user to acquire the content identified in the transmission. Such means may comprise, for example, a list of the content identified in the transmission and from which the user may select one or more of such content for acquisition. The acknowledgment may be transmitted via e-mail, for example, to a destination identified by the user. Upon receipt of the acknowledgement from the content provider, the user may elect to acquire the content identified by the content identifiers, either individually (e.g., one or more of the content) or collectively (e.g., acquiring all of the content) by transmitting an acquisition or order request to the content provider. The order request may also include payment authorization details enabling the content provider to charge the user for the ordered content. The content provider then transmits the content to the user's computing device, docking station, and/or other computing device identified by the user, where a copy of the acquired content is permanently stored and owned by the user. The computing device that receives the content from the content provider may be a portable personal content playback device that may be used by the user to store, record and/or playback content. Alternatively, the user may copy the content to such a portable personal content playback device from a computing device.

If a docking station is provided, it may be configured to receive a satellite radio receiver and to communicate with the receiver to receive, store, and/or transmit data from the receiver to another computing device. Alternatively or in addition, the docking station may be connectable to the Internet and configured for communication with other computing devices via the Internet.

An application operable with the satellite radio receiver, docking station, computing device, and/or content provider may comprise one or more modules that reside in memory in the satellite radio receiver, docking station, and/or computing device. The application provides a plurality of functions that facilitate interface between the satellite radio receiver, docking station, computing device, and/or content provider. For example, the application may facilitate a handshake between the satellite radio receiver and the docking station and/or computing device when the two devices are connected together. The application may facilitate a transfer of data from the satellite radio receiver including, by way of example and not limitation, a transfer of the one or more content identifiers captured by the user of the satellite radio receiver from the receiver to the computing device or to the content provider via the Internet, for example. Such facilitation may comprise assembling the content identifiers with a user identifier in a format suitable for transmission by the satellite radio receiver via satellite, for example, by the docking station via the Internet or to another computing device, or by the computing device via the Internet or other suitable data transmission means. Such facilitation may also comprise transmission of the data by the satellite radio receiver, docking station, and/or computing device to the content provider. The application may also receive an acknowledgement from the content provider, and may provide for the acquisition of one or more content by the user.

### BRIEF DESCRIPTION OF THE DRAWINGS

In the drawings, which are not to scale, and in which like reference characters denote similar elements throughout the several views:

FIG. 1 is schematic of a network in accordance with an embodiment of the present invention;

FIG. 2 is a schematic block diagram of a satellite radio receiver in accordance with an embodiment of the present invention;

FIG. 3 is a flow diagram depicting the capture functionality of the application program in accordance with an embodiment of the present invention;

FIG. 4 is a flow diagram depicting functionality of the application program in accordance with an embodiment of the present invention; and

FIG. 5 is a flow diagram depicting functionality of the application program in accordance with an embodiment of the present invention.

### DETAILED DESCRIPTION OF THE PREFERRED EMBODIMENTS

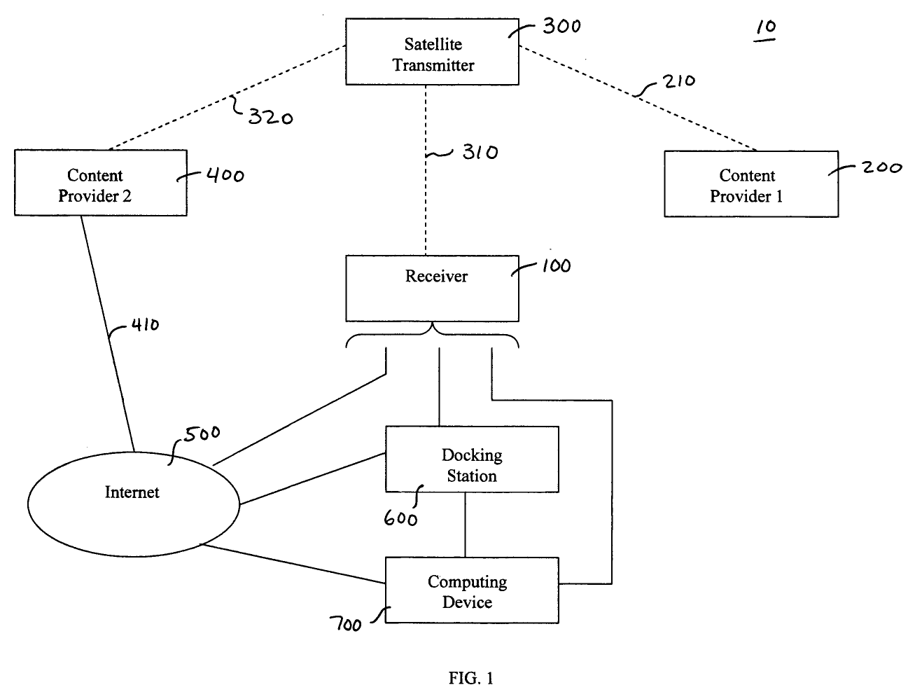

Referring now to the drawings, the present invention will be described in detail. With reference first to FIG. 1, a network for acquiring content transmitted via satellite is depicted and designated by reference character 10. In one embodiment of the present invention, the network 10 comprises a content provider 200, a receiver 100 for receiving a signal 310 from the content provider 200, and means for transmitting a signal 210 from the content provider 200 to the receiver 100. The means for transmitting the signal from the content provider 200 comprises components comprising part of at least one of content provider 200 and transmitter 300. For example, the content provider 200 may include hardware and/or software configured for transmitting a signal via satellite. The transmitter 300 may also include hardware and/or software for transmitting a signal via satellite. The present invention contemplates transmitting means comprising at least one of the content provider 200 and transmitter 300 in various combinations and configurations of hardware and software. Transmission of a signal from the content provider 200 to the receiver 100 may be accomplished by the configuration of, and interaction between and among the various elements of the network 10 depicted in FIG. 1.

The content provider 200 formats and transmits to the satellite transmitter 300 a signal 210 having a predetermined configuration and containing content and a content identifier. The signal 210 may contain other parts, as would be known to a person skilled in the art and from the disclosure provided herein. The satellite transmitter 300 receives the signal 210 from the content provider 200 and may transmit that signal without modification, or the satellite transmitter 300 may modify the signal 210 and transmit a signal 310 to the receiver 100.

In another embodiment of the present invention, and with continued reference to FIG. 1, the network 10 comprises the content provider 200, transmitter 300, receiver 100, and a second transmitting means comprising at least one of the receiver 100, a docking station 600, and a computing device 700 such as a personal computer. The second transmitting means facilitates communication between the receiver 100 and the content provider 200 or 400 for acquisition of content by the user. That communication may include a handshake between the receiver 100 and docking station 600 or computing device 700, and/or transmission by the receiver 100 to the content provider 200 or 400 of a content identifier.

If provided as part of the network 10, the docking station 600 is configured to communicate with and receive the receiver 100, to receive and/or store data from the receiver 100, and/or to transmit data from the receiver to another computing device. As noted, the other computing device may comprise a personal computer 700. The computing device 700 and/or docking station 600 may be connectable to the Internet 500 or other communication network. Thus, the receiver 100 may communicate with the docking station 600, with another computing device 700, or directly with the Internet 500, in the various combinations described herein and in various other combinations.

An application 800 operable with the receiver 100, docking station 600, and/or computing device 700 may comprise at least one of software and hardware components on one or more of the aforementioned devices. For example, the application 800 may comprise one or more software program modules that reside in memory in the receiver 100, docking station 600, or computing device 700, and/or other parts of the network 10 of the present invention. The application 800 provides a plurality of functions that facilitate interface between and among the receiver 100, docking station 600, computing device 700, and/or various other parts of the network 10, and that facilitates capture of a content identifier, transmission of the content identifier by the receiver 100, and receipt and storage of the content by the receiver 100 or other computing device.

While the present invention is described herein in terms of a satellite device, system, network and method, such description is provided as an illustrative and non-limiting example of an embodiment of the present invention. The present invention, as defined by the claims provided herein, contemplates other devices, systems, networks and methods such as, for example, broadcast radio, broadcast television, cable radio, cable television, and any other means for transmitting and receiving content.

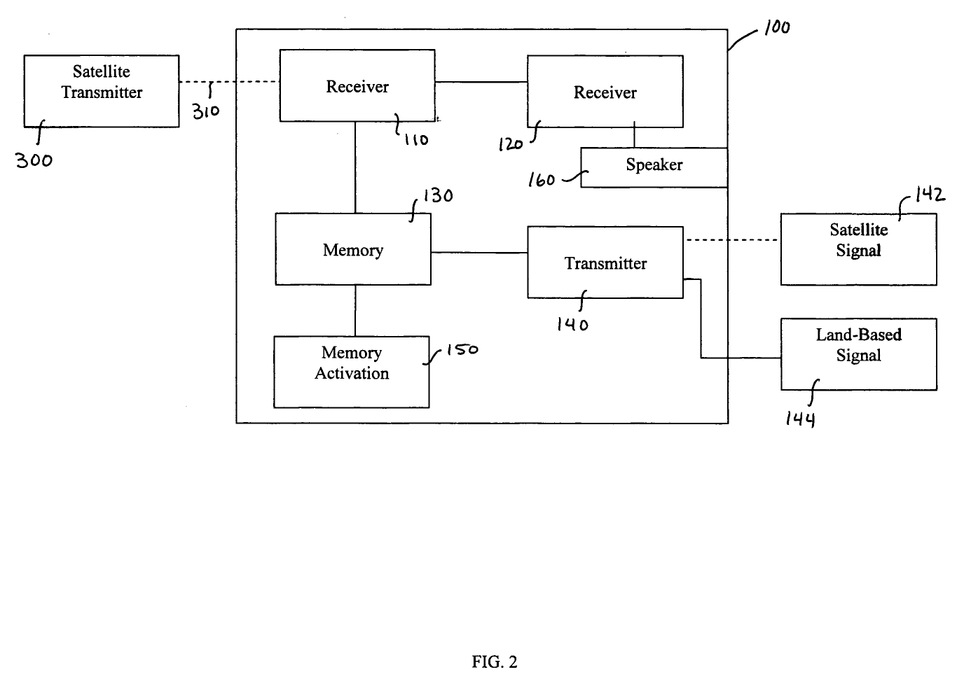

With reference next to FIG. 2, the receiver 100 of the present invention will now be described in detail. The receiver 100 comprises means for receiving a satellite signal, means for capturing a part of a content identifier transmitted in a satellite signal, and means for transmitting the part of the captured content identifier. The receiver 100 contains receiving means 110 for receiving a signal 310 transmitted via satellite. The signal 310 received by the receiver 110 may be conditioned by a conditioner 120 that conditions the signal for playback by the receiver 100. Such conditioning may include reformatting the signal 310 so it is suitable for playback by the receiver 100 via a speaker 160 or other type of audio output means. Alternatively, the signal 310 may be suitable for playback upon receipt by the receiver 100 without the need for conditioning. The receiver 110 is operably connected to memory 130 that may selectively capture a part of the signal received by the receiver 100, 110—preferably capturing at least a part of a content identifier of the content received by the receiver 100, 110. Memory 130 may be provided as part of the receiver 100, or memory may be removably connectable to the receiver 100. For memory 130 that is removably connectable to the receiver 100, the memory 130 may be removed by a user and connected to the docking station 600 or other computing device 700. That is, either the receiver 100 or memory 130 may be connected by the user to the docking station 600 or other computing device 700 to effect transmission of the captured content identifiers as discussed in detail herein.

In accordance with the present invention, a content identifier may be captured in memory 130 upon activation of memory activation means 150. Memory activation means 150 may comprise one of user depressible means such as, for example, a pushbutton, audible means such as, for example, voice activation or recognition, or programmable means such as, for example, preprogrammed criteria (e.g., artist, song title, musical genre, etc.) that may automatically or in connection with the application 800, activate the memory 130 to capture the content identifier. To capture a content identifier, a user may manually depress a pushbutton, make an audible command, or preprogram, using functionality provided by the application 800, to automatically capture a content identifier based upon certain predetermined criteria such as, for example, a particular artist or musical genre. Other predetermined criteria are also contemplated by and within the scope and spirit of the present invention.

The memory 130 may be operably connected to a transmitter 140 for transmitting one or more content identifiers as described in more detail below. The transmitter may transmit a satellite signal 142 via a satellite transmitter, or a land-based signal 144 via a land-based transmitter. As used herein, the term “land-based transmitter” means a transmitter that utilizes a hard-wired connection, an infra-red connection, a cellular connection, or any other now known or hereafter developed means of communication that utilizes at least one component, other than the transmitter 140 or receiver 100, that is located on earth or within earth's atmosphere.

In one embodiment, the one or more content identifiers captured by the user are transferred from the receiver 100 automatically or under user control. The transferred content identifiers may then be transmitted to a content provider 200 or 400, which will then transmit the content to the user, preferably to the user's computing device 700, which may be in exchange for payment by the user to the content provider 200 or 400. The user has then acquired a copy of the content identified by the content identifier.

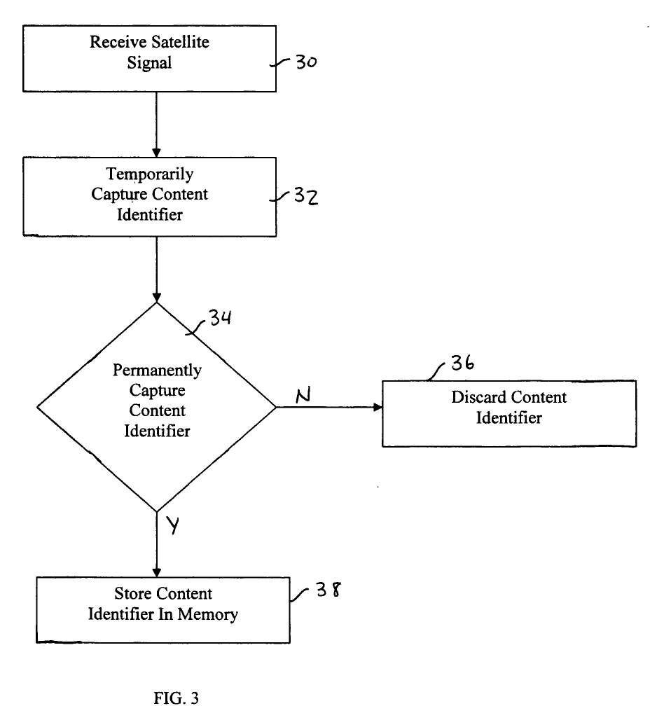

The functional characteristics of the application 800 will now be described in detail with reference to FIGS. 3-X.

Handshake Functionality

The application 800 may facilitate a handshake between the receiver 100 and the docking station 600 and/or computing device 700 when the receiver 100 is connected to at least one of the docking station 600 and computing device 700. When the receiver 100 is used in connection with a docking station 600 or other computing device 700, a handshake may occur between and among the various devices when they are first connected together. The handshake functionally of the application 800 need not be described in great detail herein, as such functionality is well-known by persons skilled in the art. For example, when a first computing device is connected to a second computing device, certain preliminary communication occurs between the two computing devices to facilitate and enable their operation.

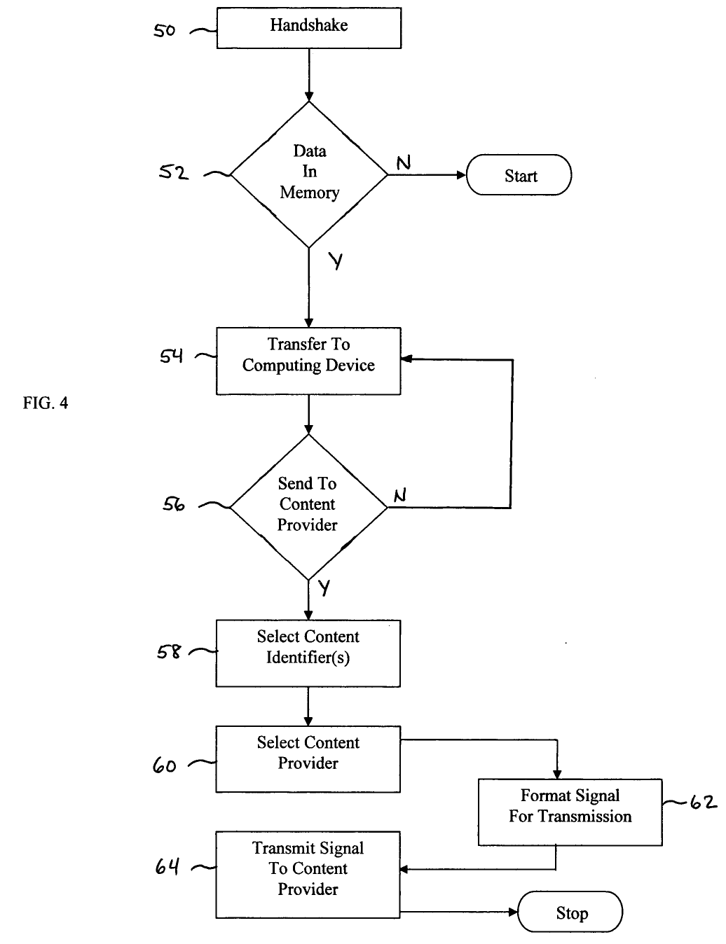

If there is data in memory 130 of the receiver 100 such as, for example, one or more content identifiers, the data may be transferred from the receiver 100 to the docking station 600 or other computing device 700, as shown by reference characters 52 and 54 in FIG. 4. The transferred data may then be transmitted to a content provider as shown by reference character 56 in FIG. 4.

### Capture Functionality

The capture functionality of the application 800 is generally depicted in FIG. 3. Generally speaking, the satellite receiver 100 receives the satellite radio signal, as depicted by reference character 30. The application 800 temporarily captures at least a part of the content identifier and stores that part in memory, as depicted by reference character 32. If the user or listener desires to permanently capture the part of the content identifier, i.e., if the user desires to acquire the content identified by the content identifier, as depicted by reference character 34, the user may activate memory 130 to store the content identifier, as depicted by reference character 38. If the user does not desire to acquire the content identified by the temporarily captured content identifier, the application 800 will discard that content identifier immediately or after a predetermined time period or under the control of the user, as depicted by reference character 36.

In addition to the content, that may be a song, for example, the satellite signal 310 may also contain data that identifies the content being transmitted, i.e., a content identifier. The application 800 facilitates capture of at least a part of the content identifier received in the satellite signal 310. The content identifier can be any data that can identify a particular content. For example, the content identifier may be a data string that identifies a specific song - that is, if the content transmitted is a song. The present invention also contemplates and is directed to any type of content—that term being used in its broadest manner herein. The application 800 can identify the content identifier in the satellite signal 310 as the signal is received by the receiver 100, and may temporarily capture the content identifier. The temporarily captured content identifier may be stored in memory 130 until the song has finished playing or some other predetermined time period. That enables a user of the receiver 100 to capture at least a part of the content identifier at any time while the song is playing or after the song has finished playing of the user's receiver 100.

The captured content identified may be permanently captured if the user desires to acquire the content identified by the content identifier upon activation by the user of memory activation 150. To capture a content identifier, the application 800 acts in response to activation of the memory activation 150. Upon activation of the memory activation 150 by the user, the application 800 captures at least a part of the content identifier and stores it in memory 130.

Format Functionality

The application 800, operating with the receiver 100, docking station 600, or computing device 700, formats the at least part of the captured content identifier in a format suitable for satellite or land-based transmission. As shown in FIG. 4, reference characters 58, 60, 62 and 64, the user may select the content identifiers of the content to be acquired—reference character 58. The user may also select the content provider from which to acquire the content—reference character 60. The application 800 then assembles the one or more content identifiers and content provider information in a format suitable for transmission via satellite or land-based transmission means—reference character 62. That formatting may include assembling the captured content identifiers and a destination identifier that may identify a content provider 200 or 400. The captured content identifiers and destination identifier may then be transmitted as a signal to the destination via satellite or via land-based transmission.

Transmit Functionality

The application 800 may facilitate a transfer of data from the receiver 100 including, by way of example and not limitation, a transfer of the one or more of the captured content identifiers to the docking station 600 and/or computing device 700, or directly to the content provider 200 or 400 via the Internet 500, for example. Such facilitation may comprise assembling the content identifiers with a user identifier in a format suitable for transmission by the receiver 100 via satellite or via the Internet 500, by the docking station 600 via the Internet 500 to another computing device (not shown), or by the computing device 700 via the Internet 500 or other suitable data transmission means. Such facilitation may also comprise transmission of the data by the receiver 100, docking station 600, and/or computing device 700 to the content provider 200 or 400. The application 800 may also receive an acknowledgement from the content provider 200 or 400, and may provide for the acquisition of one or more content by the user.

Once the signal has been formatted as described above, the application 800 also facilitates transmission of the at least part of the captured content identifier—reference character 64 in FIG. 4. The transmission may be directly by the receiver 100, by the docking station 600, or by the computing device 700.

User Profile Functionality

The application 800 will enable a user to create a user profile that may include information specific to a user. For example, the profile may contain the user's e-mail address, preferred content provider, and preferred method of payment such as a credit card number. The user profile may be stored in memory on the receiver 100 and/or computing device 700 and may be used to facilitate transmission of an order request, receipt of the desired content, payment authorization by the user to the content provider, and other functionality as described herein and as otherwise apparent from this disclosure.

Interface Functionality

The application 800 may also provide or facilitate the creation of a user interface that may be displayable on and useable in connection with a display and user input device (e.g., mouse, keyboard, etc.) of the computing device 700. The interface may facilitate selection of the content to be acquired by the user, and transmission of an order request to the content provider.

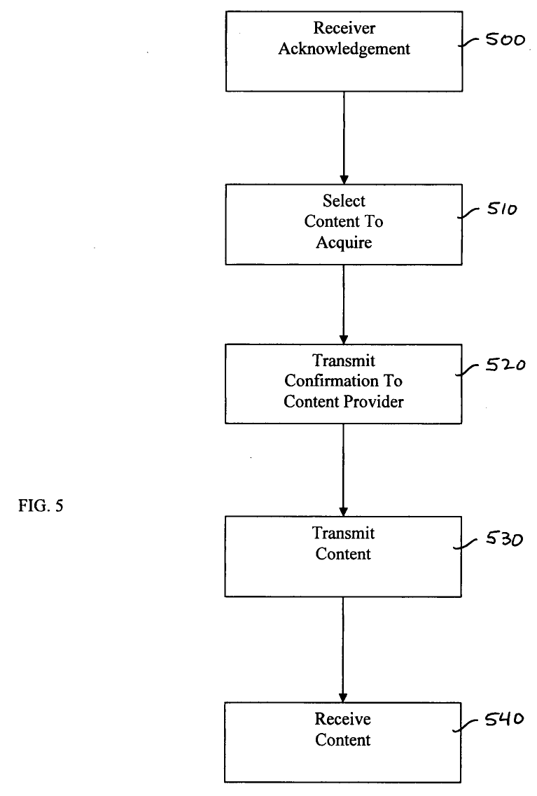

Once the user has transmitted the signal to the content provider from which the user desires to acquire the content, that content provider, utilizing functionality of the application 800 or other software program or application, may transmit an acknowledgement to the user via e-mail, for example. The acknowledgement may include a list of the songs identified by the content identifiers transmitted by the user. As depicted in FIG. 5, the user receives the acknowledgement, reference character 500 and may select one or more of the content identified on the list for acquisition, reference character 510. In making the selection, the user may transmit, via e-mail, for example, a confirmation to the content provider in the form of an order request, reference character 520. The order request may include payment information and authorization that will enable the content provider to receive payment from the user for the content provided by the content provider to the user (i.e., for the content acquired by the user). Upon receipt of the order request, the content provider 200 or 400 will transmit the content selected to the user, reference character 530—the content being received by the user, reference character 540.

The content may be received by the user's computing device and stored in permanent memory such as, for example, on a hard-drive.

The following illustrative and non-limiting description of an embodiment of the present invention is provided to illustrate one embodiment of the present invention. It will be obvious to a person skilled in the art from the disclosure provided herein that other embodiments are also contemplated by and within the scope and spirit of the present invention. A user tunes his satellite radio receiver to receive a signal transmitted via satellite by a satellite radio station. The signal contains a song and an identifier that identifies the song by title, artist, or other data that distinguishes one song from another. While listening to the song, the user may capture at least part of the identifier by depressing a capture button on the receiver or by saying a command such as “capture,” for example. Alternatively, the user may program the receiver to automatically capture the at least part of the content identifiers for a particular artist or artists, or other predetermined criteria selectable by the user. If desired, the user may capture one or a plurality of identifiers. The one or more captured identifiers are stored in memory operable in connection with the satellite radio receiver. To acquire the songs, the user may then activate a transmitter to transmit a signal having the one or more identifiers to a content provider via satellite or via land-based transmission. The user-activated transmission may occur at or near the time that the user captures the one or more identifiers, or it may occur at a later time. In addition, the user-activated transmission may be by the receiver 100, docking station 600, or other computing device 700. The content provider receives the signal with the one or more identifiers, and then notifies the user by transmitting an acknowledgement signal by e-mail, for example. Other means of transmitting the acknowledgement are also contemplated by and within the scope and spirit of the present invention. The user, upon receipt of the acknowledgement signal, can elect to acquire the content and have the content transmitted by the content provider to the user over the Internet, for example. Other means of transmitting the content from the content provider to the user are also contemplated by and within the scope and spirit of the present invention.

While an embodiment of the present invention has been described herein, other embodiments are contemplated by and within the scope and spirit of the present invention. For example, the term “content” is intended to be used in its broadest possible meaning, and to include a single content (e.g., a single song) or a collection of content (e.g., a plurality of songs). The receiver may be portable, and movable from one location to another locations (e.g., car, home, office, etc.). Alternatively, the receiver may be stationary—that is, movable to different locations, but preferably kept in a single location. An example of a stationary receiver is one used as part of a home entertainment system. A portable receiver may also be used as part of a stationary entertainment system. The memory described herein may be removable (e.g., a memory stick) or non-removable (e.g., fixed on or to a computing device). The transmission of the various signals and content described herein may occur over any type of transmission medium using any suitable transmitter and receiver.

While the invention has been described in relation to the preferred embodiments with several examples, it will be understood by those skilled in the art that various changes may be made without deviating from the spirit and scope of the invention as defined in the appended claims.

What is claimed is:

1. A system for acquiring content in a signal transmitted by a transmitter, the signal including a content identifier, said system comprising means for capturing a part of the content identifier.

2. A system as recited by claim 1, further comprising means for transmitting the part of the content identifier.

3. A system as recited by claim 1, wherein said means for capturing comprises memory means.

4. A system as recited by claim 1, wherein said means for capturing is user activatable.

5. A system as recited by claim 4, wherein said means for capturing is user activatable by one of a depressible means, an audible means and a programmable means.

6. A system as recited by claim 5, wherein said programmable means is programmable by a user to define criteria of content for which said means for capturing captures the part of a content identifier.

7. A system as recited by claim 1, further comprising a receiver for receiving the signal.

8. A system as recited by claim 7, wherein said receiver includes said means for capturing.

9. A system as recited by claim 2, wherein said means for transmitting comprises one of a satellite transmitter and a land-based transmitter.

10. A system as recited by claim 7, wherein said means for transmitting comprises one of said receiver, a satellite transmitter and a land-based transmitter.

11. A system as recited by claim 1, wherein said means for transmitting is user activatable.

12. A system as recited by claim 11, wherein said means for transmitting is user activatable by one of a depressible means, an audible means and a programmable means.

13. A system as recited by claim 12, wherein said programmable means is programmable by a user to define a condition for which said means for transmitting transmits said content identifier.

14. A system as recited by claim 1, wherein the content is audio content and wherein the content identifier identifies one of a title, creator, distributor, publisher and source of the audio content.

15. A system as recited by claim 7, wherein the transmitter transmits a plurality of signals via satellite, and wherein said receiver further comprising means for selecting one of the plurality of signals transmitted by the transmitter.

16. A network for transmitting a signal and for receiving the signal, the signal comprising content and a content identifier, said network comprising:
a transmitter for transmitting the signal; and
a receiver for receiving the signal comprising means for capturing a part of the content identifier.

17. A network as recited by claim 16, wherein said transmitter comprises one of a satellite transmitter and a land-based transmitter.

18. A network as recited by claim 16, wherein said transmitter comprises a satellite transmitter and a land-based transmitter, said land-based transmitter transmitting the signal including the content and the content identifier to the satellite transmitter.

19. A network as recited by claim 16, wherein said receiver further comprises a transmitter for transmitting the part of the content identifier.

20. A network as recited by claim 16, wherein said means for capturing comprises memory means.

21. A network as recited by claim 16, wherein said means for capturing is user activatable.

22. A network as recited by claim 16, wherein said means for capturing is user activatable by one of a depressible means, an audible means and a programmable means.

23. A network as recited by claim 22, wherein said programmable means is programmable by a user to define criteria of content for which said means for capturing captures the part of a content identifier.

24. A network as recited by claim 19, wherein said receiver transmitter is user activatable.

25. A network as recited by claim 24, wherein said receiver transmitter is user activatable by one of a depressible means, an audible means and a programmable means.

26. A network as recited by claim 25, wherein said programmable means is programmable by a user to define a condition for which said receiver transmitter transmits said content identifier.

27. A network as recited by claim 16, wherein the content is audio content and wherein the content identifier identifies one of a title, creator, distributor, publisher and source of the audio content.

28. A network as recited by claim 16, wherein the transmitter transmits a plurality of signals via satellite, and wherein said receiver further comprising means for selecting one of the plurality of signals transmitted by the transmitter.

29. A method for acquiring content in a signal received by a receiver, the signal including content and a content identifier identifying the content, said method comprising the steps of:
receiving the signal;
capturing a part of the content identifier; and
transmitting the part of the content identifier.
